(19) United States
(12) Patent Application Publication
(10) Pub. No.: US 2023/0120355 A1
(43) Pub. Date: Apr. 20, 2023

(54) SHIELD TERMINATION SYSTEM THAT ELIMINATES CABLE SHIELD DRAIN-WIRES

(71) Applicant: Hamilton Sundstrand Corporation, Charlotte, NC (US)

(72) Inventors: Robert C. Hoeckele, Granby, CT (US); Jitendra J. Solanki, Belvidere, IL (US); David J. Manna, Middletown, CT (US)

(21) Appl. No.: 17/506,008

(22) Filed: Oct. 20, 2021

(51) Int. Cl. H01R 13/6597; H01R 13/58

(52) U.S. Cl. CPC H01R 13/6597; H01R 13/5808

(57) ABSTRACT

A connector assembly or wiring unit that includes one or more wiring cables, each cable unit including one or more wires surrounded by a cable shield, a connector backshell, and a ferrule disposed such that the one or more wires are arranged on an outer surface of the ferrule. In one embodiment, the connector assembly or wiring unit also includes a conductive shield sock electrically coupled to the connector backshell. The shield sock surrounds the ferrule and is in electrical contact with the cable shield of each of the one or more wiring cables.

### BACKGROUND

Exemplary embodiments of the present disclosure pertain to the art of electrical connections and, in particular, to terminating cable shields.

In aircrafts, multiple wiring harnesses are included to connect different components that can provide power and/or signal transfer capabilities for controlling and/or transferring data between the components. Such harnesses can include multiple wires or wire groups (e.g., twisted pairs). Each of the wires or groups can include a shield to keep Electromagnetic Interference (EMI) between wires or from external RF environment low. Such a shield is typically in the form of a screen and each shield is typically terminated (e.g., connected to ground) by a drain wire that is commonly referred to as a pig tail.

Current cable and harness manufacturing techniques can be large contributors to Electromagnetic Interference (EMI) outages. Specifically, termination methods that use drain-wires (pig tails).

### BRIEF DESCRIPTION

Disclosed is a connector assembly or wiring unit that includes one or more wiring cables, each cable unit including one or more wires surrounded by a cable shield, a connector backshell, and a ferrule disposed such that the one or more wires are arranged on an outer surface of the ferrule. In one embodiment, the connector assembly or wiring unit also includes a conductive shield sock electrically coupled to the connector backshell. The shield sock surrounds the ferrule and is in electrical contact with the cable shield of each of the one or more wiring cables.

In addition to one or more of the features described above, or as an alternative to any of the foregoing embodiments, the ferrule is conductive or can have a conductive outer surface.

In addition to one or more of the features described above, or as an alternative to any of the foregoing embodiments, the ferrule can include a hollow core and has one or more additional wires disposed within the hollow core.

In addition to one or more of the features described above, or as an alternative to any of the foregoing embodiments, the ferrule can be integrally formed as part of the connector backshell.

In addition to one or more of the features described above, or as an alternative to any of the foregoing embodiments, the sock can integrally formed with the connector backshell.

In addition to one or more of the features described above, or as an alternative to any of the foregoing embodiments, the one or more wiring cables includes first portion and a second portion, the first portion is arranged on the outer surface of the ferrule and is surrounded by a conductive retainer and the second portion surround the first portion and the conductive retainer and is electrically connected to the shield sock. The second portion can contacts the shield sock.

In addition to one or more of the features described above, or as an alternative to any of the foregoing embodiments, the unit or connector can includes a clamp surrounding the shield sock and the second portion.

In addition to one or more of the features described above, or as an alternative to any of the foregoing embodiments, the system can include a first clamp surrounding the shield sock and the one or more wiring cables and a second clamp surrounding the back shell and the one or more wiring cables that connects the one or more wiring cables to the backshell.

In addition to one or more of the features described above, or as an alternative to any of the foregoing embodiments, the ferrule can include a first diameter and a second diameter.

In addition to one or more of the features described above, or as an alternative to any of the foregoing embodiments, the one or more wiring cables include a first portion having first size and a second portion having a second size and the first portion is arranged of over the first diameter and second portion is arrange over the second diameter.

In addition to one or more of the features described above, or as an alternative to any of the foregoing embodiments, the shield sock can be formed of braided material.

In addition to one or more of the features described above, or as an alternative to any of the foregoing embodiments, the shield sock is banded to the backshell with a band that surround the backshell and the one or more wiring cables.

Also disclosed is a wiring unit or connector that includes one or more wiring cables, each cable unit including one or more wires surrounded by a cable shield, wherein the cable shield is exposed and a connector backshell. In this embodiment, a conductive ferrule is disposed such that the one or more wires are arranged on an outer surface of the ferrule and the cable shields are in electrical contact with the conductive ferrule and a conductive connector that connects the conducive ferrule to the connector backshell is provided. This can remove the sleeve described above. In this embodiment, all of the above variations are possible as long as the sock is omitted.

### BRIEF DESCRIPTION OF THE DRAWINGS

The following descriptions should not be considered limiting in any way. With reference to the accompanying drawings, like elements are numbered alike:

FIG. 1 is side view of wiring connector assembly having a portion of a backshell removed to show certain connections disclosed herein;

FIG. 2 is a cross-section of an example of a wiring cable;

FIG. 3 is a cross-section of FIG. 1 taken along line 3-3;

FIG. 4 shows an alternative embodiment to that of FIG. 3 with additional wires inside the ferrule;

FIG. 5 is side view of wiring connector assembly having a portion of a backshell removed to show certain connections disclosed herein and illustrating a band coupling wiring cable screens to the backshell;

FIG. 6 is a cross-section showing an alternative to FIG. 3 where the wiring cables are divided into two portions;

FIG. 7 is a cross-section showing an alternative to FIG. 3 where the wiring cables from two portions of different sizes and surround a ferrule with partition to accommodate different outer diameters;

FIG. 8 shows an embodiment with a backshell that includes an integrally formed ferrule; and

FIG. 9 shows another embodiment that does not include a sock but can include all other elements as described herein.

### DETAILED DESCRIPTION

A detailed description of one or more embodiments of the disclosed apparatus and method are presented herein by way of exemplification and not limitation with reference to the Figures.

As discussed above, the shields of wires in an aircraft (or other vehicle) can be connected to a common or ground point via a drain wire. However, it has been discovered that such drain wires have higher impedance than the shield, and they can introduce larger “loop area” than a direct shield termination. As such, the drain wires can reduce the effectiveness of cable shielding for the protection against radio-frequency (RF) susceptibility threats or lead to higher EMI emissions.

Herein disclosed are systems and methods where electrical connections of individual cable shields is achieved within the harness design without the use of any shield drain-wires separately attached to the shields. Connections can be made near where cables enter the backshell making for improved shield terminations and reduced assembly steps. Such shield termination eliminates the use of drain wires producing lower impedance and smaller “loop area” termination for shields.

One or more embodiments may minimize the extent of the exposed or unshielded signals at the connector entry to reduce susceptibility due to cross coupling between signals and from shield drain wires in the unshielded area. As will be understood, the systems and methods can improve reliability for robust and longer-term field performance and may improve manufacturability of the harness when compared to termination methods that use shield drain-wires.

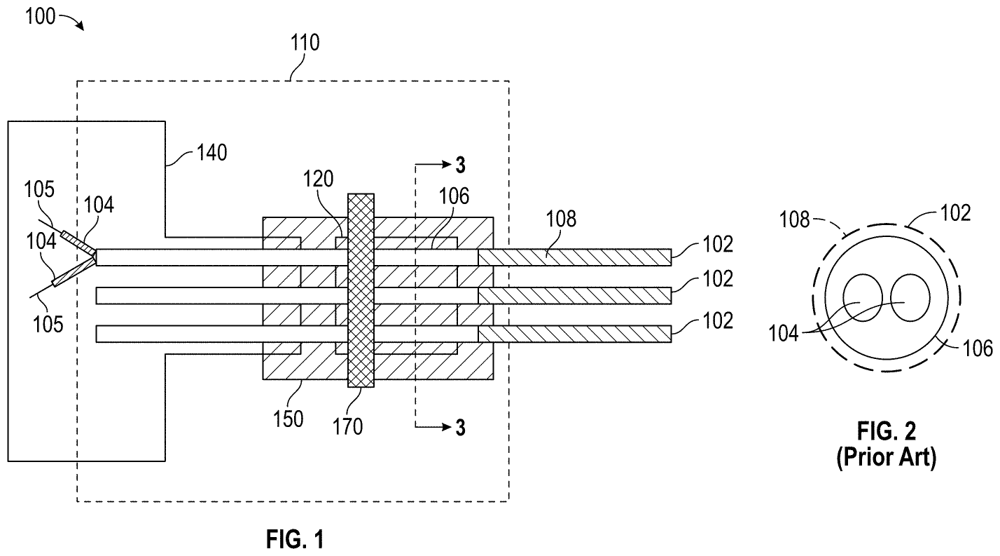

FIG. 1 shows an example of one end of cable harness 100. This end can be referred as a termination portion of the harness 100 and can be referred to as a “connector assembly” or “wiring unit” herein from time to time. In one embodiment, all ends of the harness can include the connector assembly or wiring unit disclosed herein but that is not required.

The cable harness 100 includes one or more wiring cables 102. Each of one or more wiring cable can include at least one conductor and a shield as best seen in FIG. 2. In FIG. 2, the wiring cable 102 includes 2 conductors (e.g., wires) surrounded by a shield 106. Of course, the cable could include more or less than 2 conductors in some embodiments. In one embodiment, the cable includes a twisted pair of conductors 104. For consistency, in FIGS. 1, 5 and 9, one of the cable is shown as being a twisted pair with wires 104 extending from it. The skilled artisan will realize any type of cable can be used and all of the figures can be assumed to show the different possible wire configurations of each cable 102 in all of the figures.

The shield 106 can be formed of a solid or braided conductive material. The shield is surrounded by an insulator 108. As discussed more fully below, embodiments herein include methods that remove some the insulator 108 so that the shield is exposed. In other embodiments, the cable 102 can be formed such that it does not have an insulator 108 around it. Thus, the insulator 108 is shown as being optional in FIG. 2.

Referring now to both FIGS. 1 and 2, in a region 110 near the end of the cable harness 100 the ends of the conductors 104 can have the insulator 108 removed to expose the shield 106 of each cable 102. In FIG. 1 the insulator 108 is shown as being textured whereas the shield 106 is shown as being untextured in an effort to more clearly illustrate the difference.

A ferrule 120 is provided in one embodiment. The ferrule is conductive or has a conductive outer layer in one embodiment. The cables are arranged on or around an outer surface 122 of the ferrule 120 in a region where the shield 106 is exposed.

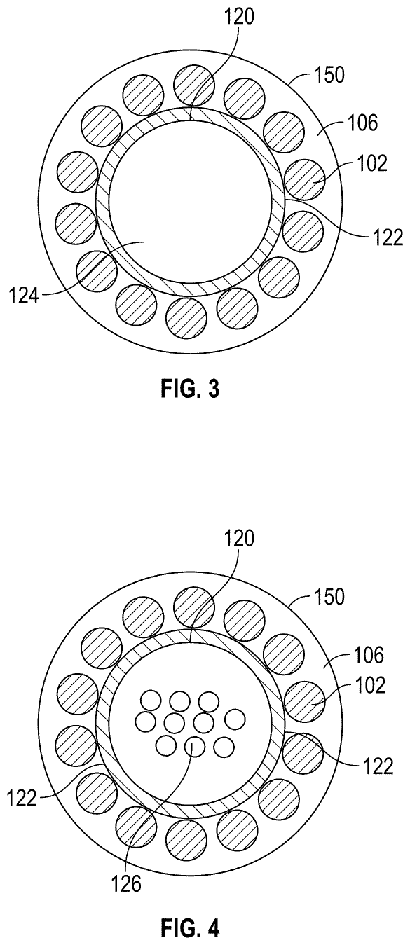

With reference now to FIG. 3, a cross section taken along line 3-3 is shown. In FIG. 3, the ferrule 120 is shown as a hollow ring having a generally circular shape. While not required, by having the ferrule 120 formed of conductive material (or having a conductive outer surface) all of the shields 106 of the cables are electrically connected when secured with a band 170 or other fastener. This can create a more stable ground/reference for the shields and/or when secured with a band 170 (FIG. 1) or other fastener.

The illustrated ferrule 120 is shown as being a cylinder having a hollow core (inner region 124). This hollow region 124 could be filled with unshielded wires 126 in one embodiment and as shown in FIG. 4.

The skilled artisan will realize that as now described, the shields are exposed on an outer surface and electrically connected to the other cables either due to their contact with one another or via the ferrule 120 (or both). Embodiments herein also include a connector backshell 140. A backshell is a well know element used in cable harnesses and a cut-away view of an example backshell 140 is shown in FIG. 1. The backshell generally provides a physical element to terminate a harness such as harness 100 so that it can be connected to another element. In one embodiment, the backshell 140 is electrically conductive and may be grounded to another element when connected to it.

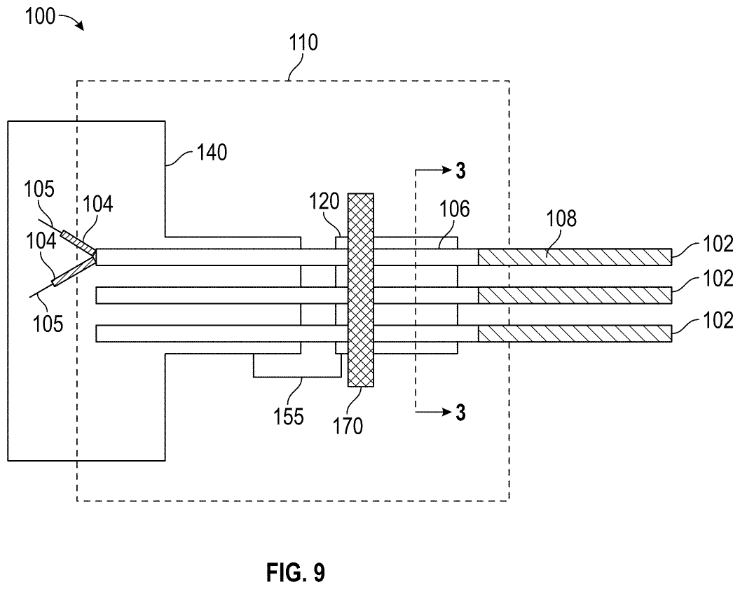

The illustrated harness 100 also includes a conductive sock 150 connected to the backshell 140. The conductive sock 150 can be formed as a flexible conductor that can be expanded or otherwise positioned around the ferrule 120 and the exposed portions of the shields 106 so that it makes electrical contact with the shields. In this manner, all of the shields 106 can be eclectically connected to the backshell 140 without the need for pigtails. It shall be understood, however, that in the case where ferrule is conductive, the sock may be omitted and the ferrule electrically connected to the backshell. An example of such is shown in FIG. 9 where a connector 155 such as a grounding wire electrically connects the backshell 140 to the ferrule 120 which, in this embodiment, is formed of or covered by a conductive material.

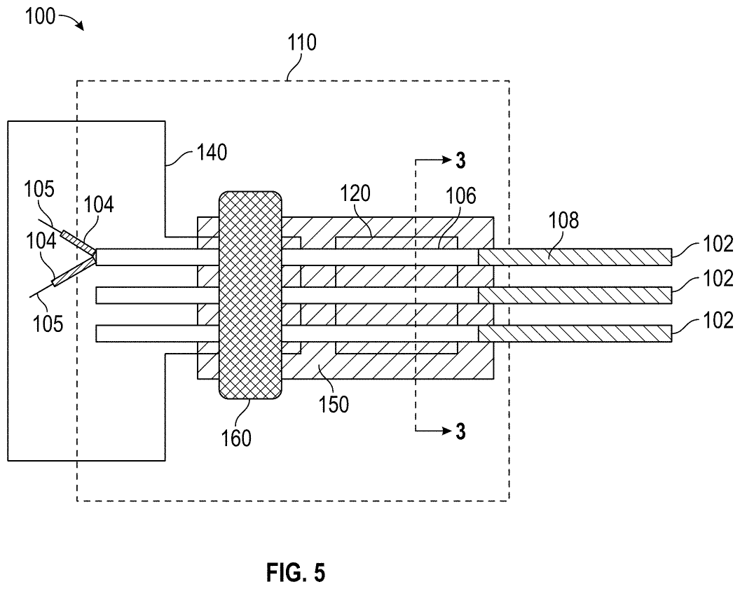

The conductive sock 150 can be permanently connected to the backshell 140 in one embodiment. For example, it can be soldered, welded or otherwise permanently attached. Alternatively, and as shown in FIG. 5, the sock 150 can be removably coupled to the backshell 140 with, for example, a band 160 or other type of removable fastener.

Similarly, the sock 150 can be permanently or removably connected to the exposed portions of the cable shields in area immediately over ferrule 120. An example of such a connection is shown in FIG. 1 and is held by a band 170 or other type fastener. An example of “other fastener” could include a heat shrink ring.

It shall be understood that portions of the embodiments of FIGS. 1 and 5 can be interchanged. For example, in FIG. 5, the band 160 can be provided and the shields either permanently coupled to the sock 150 (by welding, soldering, etc.) or removably coupled with a band such as band 170 of FIG. 1. Alternatively, the band 170 could be provided as shown in FIG. 1 and another band (such as band 160) or other fastener used to connect the sock to the backshell 140.

In the above examples, the cables 102 have been distributed evenly about the ferrule 120. While such may be beneficial, it is not required.

From the above, it shall be understood that a method of forming a wiring unit/connector assembly has also been disclosed. The method includes stripping or otherwise removing the insulator 108 from one or more individual cable 102 to expose shields 106 on each wire 104 that is part of the cable. In this method, removing can include exposing enough of the cable shield 106 to cover from the location of the ferrule 120 up to the back of the backshell 140. The ends of wires 104 forming the cable 102 can be prepared for routing to the connector pins as per the style of the connector and backshell requirements.

In one embodiment, the exposed cable shields 106 in cables 102 are bundled around the ferrule 120 such that the exposed shields are aligned and contact the outer side 122 of the ferrule 120. As discussed above, cables that are unshielded or cables which require shields to be kept isolated (for local termination) (e.g., wires 126 of FIG. 4) can optionally be routed through the inner diameter (core 124 with outer side labeled as 122) of the ferrule 120.

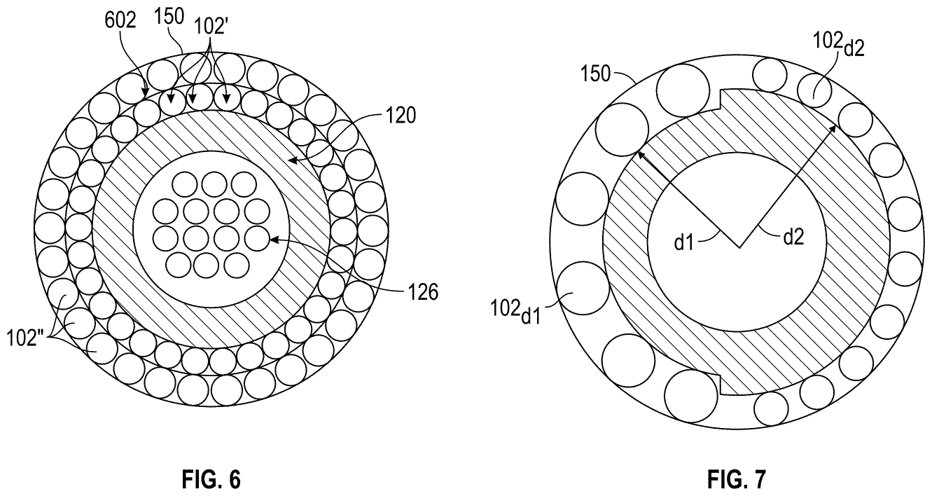

With reference now to FIG. 6, is some cases not all of the wiring cables can fit around the ferrule 120. In such a case, a first portion can be arranged around the ferrule 120 outer circumference. These wiring cables are denoted as 102′ in FIG. 6. The first portion 102′ can then have a retainer 602 (such as a wire tie) formed around them to hold them in place. The retainer 602 is conductive in one embodiment. Then, a second portion 102″ is formed around the first portions 102′ and then the sock 150 applied as described in any of the manners described above.

In other embodiments, the ferrule 120 could have different shapes than just circular. For example, as shown in FIG. 7, the ferrule could have a variable thickness so that it has two different outer diameters (d1 and d2). This can allow wiring cables of different sizes (102_{d1} and 102_{d2}) to be grouped together in a manner that all present a relatively uniform outer diameter (dₒᵤₜ) so they can effectively contact the sock 150.

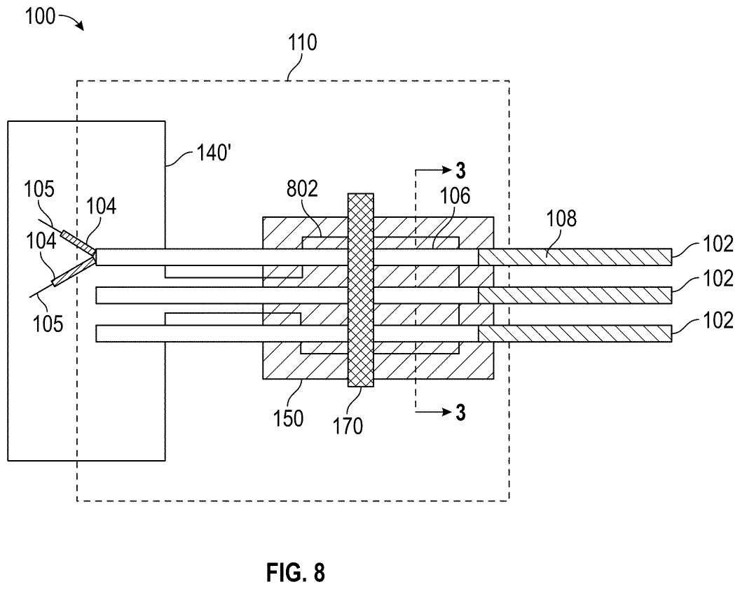

In the above embodiments, the ferrule 120 has been described as separate piece from the backshell 140. However, it could be part of or integrally connected to the backshell 140′ as shown in FIG. 8. That is, the rear portion 802 of the backshell 140′ could be configured similar to any of the ferrules 120 described above. The embodiment of FIG. 8 can be formed in any of manners described above. As mentioned above, use of sock 108 can be optional as electrical connection to the backshell is achieved with the integral ferrule that is conductive and as shown in FIG. 9.

It should be noted that shrink wrap of other binding tools (e.g., heat shrink tubing) can be used at certain locations without departing from the teachings herein. For example, the sock 150 could be surrounded by shrink wrap/heat shrink tubing before any of the bands discussed above are used or could take the place of them in one embodiment.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A wiring unit comprising:
one or more wiring cables, each wiring cable including one or more wires surrounded by a cable shield;
a connector backshell;
a ferrule disposed such that the one or more wires are arranged on an outer surface of the ferrule;
a conductive shield sock electrically coupled to the connector backshell, wherein the shield sock surrounds the ferrule and is in electrical contact with the cable shield of each of the one or more wiring cables.

2. The wiring unit of claim 1, wherein the ferrule is conductive.

3. The wiring unit of claim 1, wherein the ferrule includes a hollow core and has one or more additional wires disposed within the hollow core.

4. The wiring unit of claim 1, wherein the ferrule is integrally formed as part of the connector backshell.

5. The wiring unit of claim 4, wherein the sock is integrally formed with the connector backshells.

6. The wiring unit of claim 1, wherein the one or more wiring cables includes first portion and a second portion;
wherein the first portion is arranged on the outer surface of the ferrule and is surrounded by a conductive retainer; and
wherein the second portion surround the first portion and the conductive retainer and is electrically connected to the shield sock.

7. The wiring unit of claim 6, wherein the second portion contacts the shield sock.

8. The wiring unit of claim 7, further comprising a clamp surrounding the shield sock and the second portion.

9. The wiring unit of claim 1, further comprising a first clamp surrounding the shield sock and the one or more wiring cables.

10. The wiring unit of claim 9, further comprising a second clamp surrounding the back shell and the one or more wiring cables that connects the one or more wiring cables to the backshell.

11. The wiring unit of claim 1, wherein the ferrule includes a first diameter and a second diameter.

12. The wiring unit of claim 1, wherein the one or more wiring cables include a first portion having first size and a second portion having a second size and the first portion is arranged of over the first diameter and second portion is arrange over the second diameter.

13. The wiring unit of claim 1, wherein the shield sock is formed of braided material.

14. The wiring unit of claim 1, wherein the shield sock is integrally formed as part of the backshell.

15. The wiring unit of claim 1, wherein the shield sock is banded to the backshell with a band that surround the backshell and the one or more wiring cables.

16. A wiring unit comprising:
one or more wiring cables, each wiring cable including one or more wires surrounded by a cable shield, wherein the cable shield is exposed;
a connector backshell;
a conductive ferrule disposed such that the one or more wires are arranged on an outer surface of the ferrule and the cable shields are in electrical contact with the conductive ferrule; and
a conductive connector that connects the conducive ferrule to the connector backshell.

17. The wiring unit of claim 16, wherein the ferrule includes a hollow core and has one or more additional wires disposed within the hollow core.

18. The wiring unit of claim 16, wherein the ferrule is integrally formed as part of the connector backshell.

19. The wiring unit of claim 16, further comprising a clamp surrounding the conductive ferrule and the wires.
